(19) United States
(12) Patent Application Publication
(10) Pub. No.: US 2010/0313998 A1
(43) Pub. Date: Dec. 16, 2010

(54) SAWING AND CHIPPING DEVICE

(76) Inventor: Jean-Guy Lebreux, Quebec (CA)

Correspondence Address: LADAS & PARRY LLP, 224 SOUTH MICHIGAN AVENUE, SUITE 1600, CHICAGO, IL, 60604, US

(21) Appl. No.: 12/746,367

(22) PCT Filed: Dec. 8, 2008
(86) PCT No.: PCT/CA08/02147

§ 371 Date: Aug. 25, 2010

Related U.S. Application Data
(60) Provisional application No. 60/996,851, filed on Dec. 7, 2007.

(51) Int. Cl. A01G 23/093

(52) U.S. Cl. 144/4.1; 144/34.1; 241/101.4

(57) ABSTRACT

A sawing and chipping device for harvesting and chipping trees including a rotatable saw for cutting a tree, conveyor for conveying the cut tree and a chipping element for chipping the cut tree. The saw includes top and bottom surfaces and a peripheral edge. The chipping element is mounted on the saw top surface. When engaging a tree with the saw during rotation thereof, the tree is cut and subsequently conveyed by the conveyor onto the saw top surface to be chipped by the chipping element. In another aspect, the saw is mounted to a housing having an opening to receive tree chips leading to a container positioned beneath the saw bottom surface and including an outlet. The bottom surface includes turbine blower means for blowing the chips through said outlet during rotation of the saw. In another aspect, the conveyor is configured to convey a cut tree inwardly and downwardly. Saws for such devices are also disclosed.

### FIELD OF THE INVENTION

The present invention relates to sawing and chipping device. More specifically, the present invention relates to a device for harvesting trees via sawing and then chipping them.

### BACKGROUND OF THE INVENTION

Tree harvesting and chipping devices are well known in the art. It is convenient to combine a tree harvester with a chipping device so as to cut the tree and chip it onsite following cutting. A variety of devices are taught in the art that combine a tree harvester such as a rotary circular blade for cutting the tree and a chipper device (i.e. chipping knives). Some of these devices use a single drive for entraining both the circular blade and the chipper device. Hence, it is known to combine sawing teeth and a chipping blade on a same device. These devices are usually mounted to tractors or other like vehicles which include booms for transporting or entraining the chipped pieces of wood therein.

Many of the challenges of these combined sawing and chipping devices (or tree harvester and chipping devices) is the transporting of cut tree to the chipping device and the entraining of the chipped pieces.

In one example of a known device, the tree harvester is mounted to a tractor for handling, cutting and chipping trees. This harvester includes a rotary saw for cutting a tree near the ground level, transport means, adjacent to the rotary saw, for gripping, transporting and dropping the cut tree into a chipper positioned at a distance from the rotary saw. The transport means includes a pair of opposed conveyors having respective laterally extending fingers for gripping and transporting the tree therebetween.

In another known example, the art teaches a tree harvester having a horizontally-revolving mower positioned near the ground for cutting a tree. A conveyor, such as a tapering worm, guides the cut tree to a chopping means. After chopping, the conveyor guides the chopped pieces to an ejection element. The conveyor element is disposed in such a manner that it allows for vertical-forced feeding of the tree into the chopping means. The resulting chopped pieces are drawn below the conveyor elements.

The art also teaches a harvester having a rotating conical body with a circular saw blade at its bottom end that includes chipper knives along its circular periphery. Other devices include wood harvesters having a cutting rotor and a crushing rotor. The crushed material is collected by a worm gear and then blown to a container by a turbine. Still other devices include an edger saw that combines a chipper with a circular saw blade.

A drawback of these devices is that they are large assemblies which are complex and expensive to build and maintain thus being inconvenient.

### OBJECTS OF THE INVENTION

An object of the present invention is to provide a sawing and chipping device.

### SUMMARY OF THE INVENTION

In accordance with an aspect of the present invention, there is provided a sawing and chipping device for harvesting and chipping trees, the device comprising:

a rotatable saw comprising top and bottom surfaces and a peripheral edge;

a chipping element being mounted on the saw top surface; and

a conveyor for conveying a cut tree,

wherein when engaging a tree with the saw during rotation thereof, the tree is cut and subsequently conveyed by the conveyor onto the saw top surface to be chipped by the chipping element.

A sawing and chipping device for harvesting and chipping trees, the device comprising:

a rotatable saw rotatably mounted to a housing and comprising top and bottom surfaces and a peripheral edge, the bottom surface comprising turbine blower means, the housing comprising an opening adjacent the saw top surface, and leading to a container positioned underneath the saw bottom surface and comprising an outlet;

a chipping element positioned near the opening; and

a conveyor for conveying a cut tree,

wherein when engaging a tree with the saw during rotation thereof, the tree is cut and subsequently conveyed by the conveyor to the chipping element to be chipped thereby producing chips, the rotational movement of the saw conveying the chips into the container via the opening, said turbine blower means providing for blowing the chips through the outlet during rotation of the saw.

In accordance with another aspect of the present invention, there is provided a sawing and chipping device for harvesting and chipping trees, the device comprising:

a housing comprising a bottom body portion and an upper body portion upstanding therefrom;

a rotatable saw rotatably mounted to the bottom body portion for cutting a tree during rotation thereof;

a conveyor for conveying the cut tree, the conveyor being mounted to the upper body portion and extending therefrom above the saw,

wherein when engaging a tree with the saw during rotation thereof, the tree is cut and subsequently conveyed by the conveyor towards the upper body portion.

In accordance with a further aspect of the present invention, there is provided a saw for being rotatably mounted to a sawing and chipping device for harvesting and chipping trees, the saw comprising

a top surface;

a central mounting element for being mounted to an actuator for imparting a rotational movement to the saw, a peripheral edge for engaging and cutting a tree during rotation of the saw;

a chipping blade mounted along the saw top surface so as to chip the cut tree in the same plane as the cutting action of the saw; and

a bottom surface opposite the top surface.

In accordance with still another aspect of the present invention, there is provided a saw for being rotatably mounted to a sawing and chipping device for harvesting and chipping trees, the saw comprising

a top surface;

a central mounting element for being mounted to an actuator for imparting a rotational movement to the saw,

a peripheral edge for engaging and cutting a tree during rotation of the saw;

a bottom surface opposite the top surface comprising turbulating fins for acting as a blower during rotation of said saw.

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a front perspective view of the sawing and chipping device in accordance with a non-limiting illustrative embodiment of the present invention;

FIG. 2 is right lateral side view of the sawing and chipping device of FIG. 1;

FIG. 3 is a left lateral side view of the sawing and chipping device of FIG. 1;

FIG. 4 is a left rear view of the sawing and chipping device of FIG. 1;

FIG. 5A is top plan view of the circular saw of the present chipping device in accordance with a non-restrictive illustrative embodiment of the present invention;

FIG. 5B is a bottom view of the circular saw of FIG. 5A; and

FIG. 5C is a lateral side elevational view of the circular saw of FIG. 5A.

### DETAILED DESCRIPTION OF ILLUSTRATIVE EMBODIMENTS

With reference to the appended drawings, a non limiting illustrative embodiment of the sawing and chipping device will be described herein so as to exemplify the invention and not limit the scope thereof.

Generally stated the present invention is concerned with a device for cutting off, i.e. harvesting, and chipping a tree. The device comprises a main body, a circular saw, a chipping blade, a conveyor, a container case and a blower.

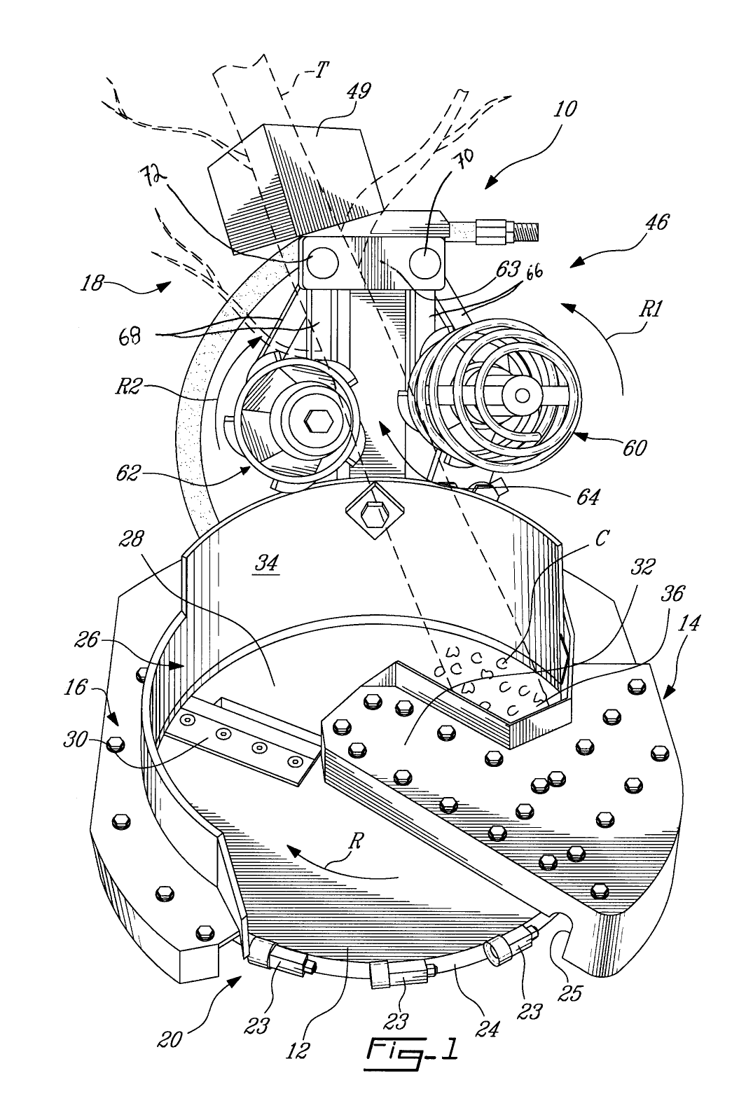

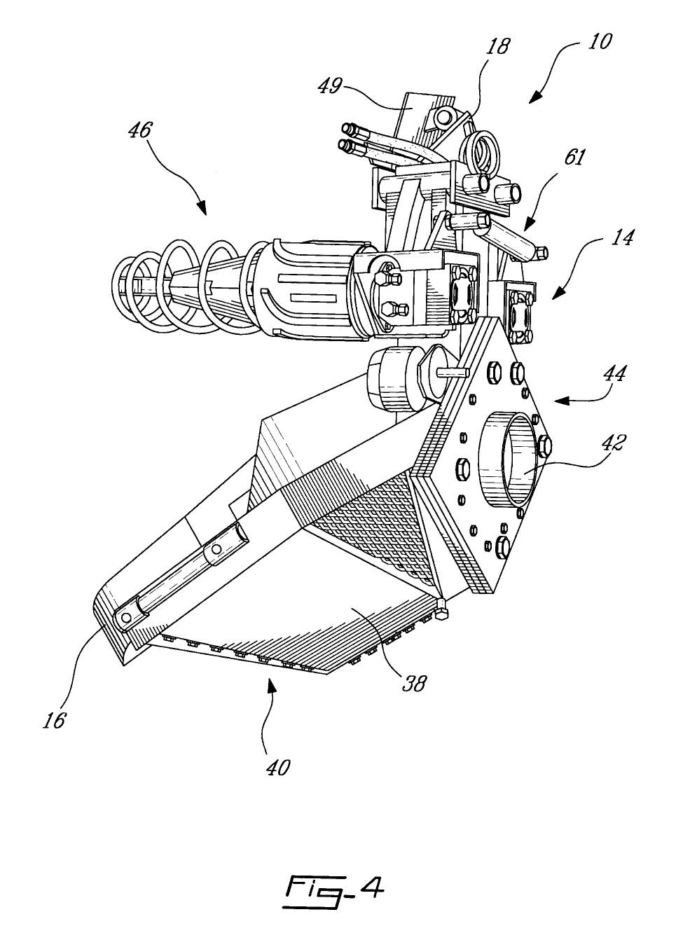

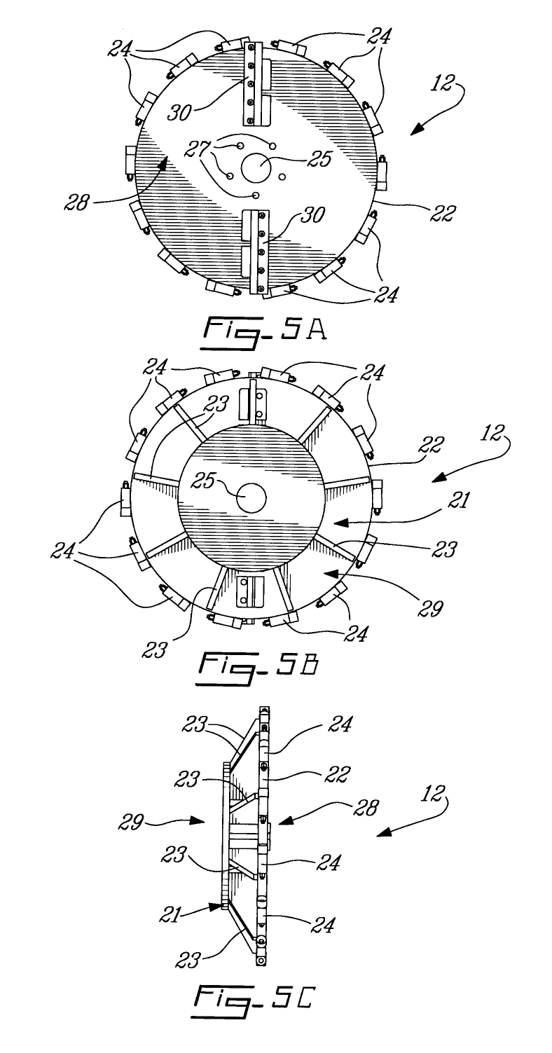

Referring to FIGS. 1 to 4, the device 10 includes a circular saw 12 rotatably mounted to a main body 14 which generally acts as a housing. The main body 14 includes a bottom body portion 16 and an upper body portion 18. The bottom body portion 16 houses the circular saw 12 and in this regard provides a front open space 20 for a leading edge 22 of the circular saw 12, exposing the sawing teeth 23 thereof. It is this leading edge 22 that engages the trunk or stem of a tree T during sawing. The circular saw 12 rotates within a recess 25 formed within the main body bottom portion 16. The main body bottom portion 16 also defines an open top space 26 for partially exposing the top surface 28 of the circular saw 12. An elongate chipping blade 30 extends along the radius of the top surface 28 of the circular saw 12.

As is known in the art, the circular saw 12 is powered by an actuator (not shown) carried within the main body bottom portion 16. The circular saw 12 is mounted to a centre portion 32 of the main body bottom portion 16 via an axle (not shown). In this way, the circular saw 12 and the chipping blade 30 are rotated in the same plane as shown by arrows R.

With particular reference to FIGS., 5A, 5B and 5C, the circular saw 12 includes a circular edge 22, a top surface side 28 and opposite underside or bottom surface 29. The saw teeth 24 extend from the edge 22 of the circular saw blade 12. The saw teeth can be set at an angle relative to the edge 22. In this example, two oppositely disposed chipping blades 30 are mounted to the top side or surface 28 of the circular saw blade 12 along the same diameter. The underside 29 of the circular saw 12 defines a turbine blower 21 which includes turbulating fins 23. The circular saw includes a central mounting hole 25 for receiving an actuator as well as mounting apertures 27.

It should be noted that a variety of turbine blower means can be formed on the bottom surface or underside 29 as to provide the blowing action described herein.

Turning back to FIGS. 1 to 4, the main body bottom portion 16 also includes a guiding arcuate wall 34 that is adjacent to the top open space 26. The arcuate guiding wall 34 leads towards an opening 36 within the main body bottom portion 16 that leads into a container case 38 formed at the bottom side 40 of the main body bottom portion 16 and is defined beneath the surface of the circular sawing of the blade 12. The container case 38 has an outlet opening 42, defined at the rear 44 of the main body bottom portion 16, for mounting a tube or other exhaust on an articulating boom for example. The container case 38 may include auxiliary fans (not shown) that can work in conjunction with the turbine blower 21. In another embodiment of the invention, the auxiliary or additional fans are remote from the apparatus 10

The main body upper portion 18 is in the form a generally vertical member including a conveyor assembly 46 and a top holding member 49.

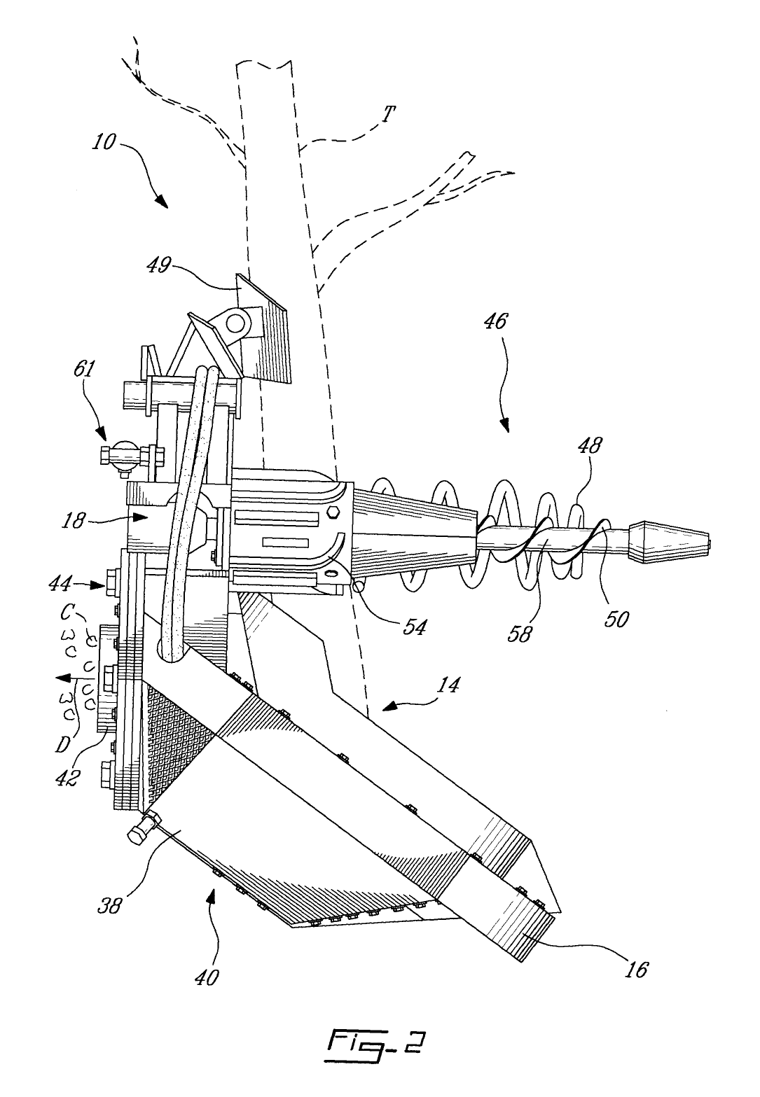

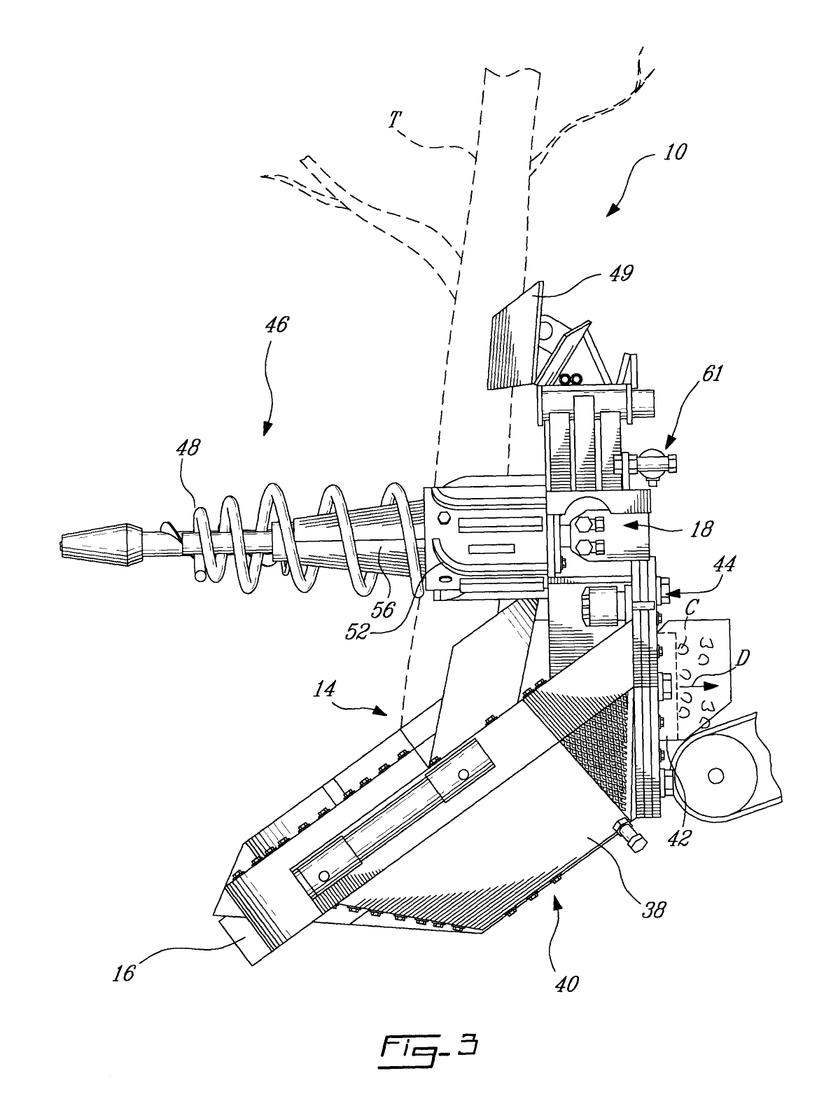

With particular reference to FIG. 1, the conveyor assembly 46 includes a pair of spaced apart arm structures 60 and 62 having respective rear ends extending from the main body upper portion 18 above the circular blade 12 thereby defining respective free ends. Turning to FIG. 3, the arm 62 comprises a first conic worm gear 48 and first spur gear 52 coaxially mounted to a first rotating axle 56, which is rotatably mounted to the main body upper portion 18, and projects therefrom above the circular blade 12. The first spur gear 52 is located closer to the main body upper portion 16 than the first worm gear 48. With respect to FIG. 2, the arm 60 comprises a second conic worm gear 50 and a second spur gear 54 coaxially mounted to a second rotating axle 58, which is rotatably mounted to the main body upper portion 16, and projects therefrom above the circular blade 12. The second spur gear 54 is located closer to the main body upper portion 18 than the second worm gear 50. The first and second worm gears, 48 and 50, respectively, have corresponding structures. Similarly the first and second spur gears, 52 and 58, also have corresponding structures.

Hence, the first spur and worm gears 52 and 48 define a first spur-worm gear assembly 60 and the second spur and worm gears 54 and 50 define a second spur-worm gear assembly 62. The two corresponding spur-worm gear pairs or arm structures 60 and 62 are positioned substantially at the same height, generally parallel to one another and define a space 64 therebetween. The two corresponding spur-worm gear pairs 60 and 62 are powered by an actuator within the main body upper portion 18 so as to rotate in the direction shown by arrows R1 and R2.

The two corresponding spur-worm gear pairs 60 and 62 are attached together by an actuator 61 to maintain sufficient pressure on the stem T hence, opening (i.e. moving the arm structures 60 and 62 away from one another) and closing (i.e. moving the arm structures 60 and 62 towards each other) as need be about the pivoting point 63. More specifically, the rear ends of the arm structures 60 and 62 are mounted to respective extensions 66 and 68 pivotally mounted at respective pivots 70 and 72 to a backing panel 74.

In operation, the circular blade 12 and the two corresponding spur-worm gear assemblies 60 and 62 are actuated to rotate as the device 10 engages a tree T. Hence, the tree T is cut off by the rotational movement of the sawing teeth 24 simultaneously; the rotation of the two first and second worm gears 48 and 50 engages the cut tree T in the space 64 therebetween and conveys the tree T toward the main body upper portion 18. In some cases, as the spur-worm gear assemblies 60 and 62 convey the tree inwardly into space 64, they can simultaneously break off branches from the tree stem T. Depending on the thickness of the stem T, the spur-worm gear assemblies 60 and 62 are actuated to be brought closer or be moved further away from each other so as to properly grip the tree stem T therebetween.

The arcuate guiding wall 34 serves to keep the bottom end of the tree T in place as it being displaced. When the cut-off tree T reaches the first and second spur gears 52 and 54 the tree is then pushed down onto the top surface 22 of the circular blade 12. The top of the tree T is kept in position by the top holding member 49 and the bottom of the tree T is kept in place by the circular guiding wall 34 and is chipped under the action of the rotating chipping knife. The holding member 49 also acts as a shire that cuts branches off the tree stem T during operation.

Under the rotation of the circular blade 12, the chips C of the tree T are projected into the case 38 by being deflected therein by the chipping blade 30. The chips C are then blown out of the case 34, under the action of the turbine blower 21, via the outlet 42 in the direction shown by arrow D. Hence, the rotation of the circular saw 12 spins the turbulating fins 23 of the turbine blower creating turbulence within the case 38 which causes the chips C to be blown out of the outlet 42. The foregoing can also be aided via the fans discusses above.

The device 10 needs only one motor to simultaneously perform the cutting, chipping and blowing functions, since the sawing teeth 23, the chipping knife or blade 30 and the turbine blower are all mounted to the same circular saw 12. The device 10 does not need a clamp for handling a tree T after it has been cut off, nor does it need an entraining means for dragging the chips into the case.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention.

1. A sawing and chipping device for harvesting and chipping trees, said device comprising:
a housing comprising an opening leading to a container comprising an outlet;
a rotatable saw mounted to said housing and comprising top and bottom surfaces and a peripheral edge, said bottom surface comprising a turbine blower, said container being positioned underneath said bottom surface;
a chipping element being mounted on said saw top surface; and
a conveyor for conveying a cut tree,
wherein when engaging a tree with said saw during rotation thereof, the tree is cut and subsequently conveyed by said conveyor onto said saw top surface to be chipped by said chipping element, the chips produced thereby being conveyed into said container and said turbine blower providing for blowing the chips through said outlet.

2.-3. (canceled)

4. A sawing and chipping device according to claim 1, wherein said chipping element comprises a chipping blade mounted along said saw top surface so as to chip the cut tree in the same plane as the cutting action of said saw.

5.-6. (canceled)

7. A sawing and chipping device according to claim 1, wherein said housing comprises an open front end for exposing a leading edge of said saw.

8. A sawing and chipping blade according to claim 1, wherein said housing comprises an open top space for exposing said saw top surface and said chipping element providing for the tree to be conveyed thereon during chipping.

9. (canceled)

10. A sawing and chipping device according to claim 1, wherein said opening is adjacent said saw top surface.

11.-13. (canceled)

14. A sawing and chipping device according to claim 1, wherein said turbine blower comprises turbulating fins.

15. A sawing and chipping device for harvesting and chipping trees, said device comprising:
a housing defining a front end and a back end;
a rotatable saw comprising top and bottom surfaces and a peripheral edge;
a chipping element being mounted on said saw top surface; and
a conveyor for conveying a cut tree, said conveyor providing to convey the cut tree along said saw top surface from said front end towards said back end, said conveyor conveying the cut tree onto the said saw top surface to be chipped by said chipping element near said back end,
wherein when engaging a tree with said saw during rotation thereof, the tree is cut and subsequently conveyed by said conveyor onto said saw top surface to be chipped by said chipping element.

16. A sawing and chipping device according to claim 15, wherein said housing comprises an opening near said back end thereof for the evacuation of chipping elements produced, said opening being adjacent said saw top surface.

17. A sawing and chipping device according to claim 15, wherein said housing comprises an open top space for exposing said saw top surface and said chipping element providing for the tree to be conveyed thereon during chipping, said housing further comprising a guiding wall adjacent said top space.

18. A sawing and chipping device according to claim 1, wherein said housing comprises a bottom body portion thereof for carrying said saw and an upper body portion generally upstanding from said bottom body portion.

19. A sawing and chipping device according to claim 18, wherein said conveyor is mounted to said upper body portion.

20. A sawing and chipping device according to claim 19, wherein said conveyor comprises a pair of spaced apart arm structures extending from said upper body portion above said saw for engaging and conveying therebetween the cut tree.

21. (canceled)

22. A sawing and chipping assembly according to claim 20, wherein said spaced apart arm structures are movable mounted to said upper body portion so as to be selectively moved towards or away from each other during conveying of the cut tree.

23. A sawing and chipping device for harvesting and chipping trees, said device comprising:
a rotatable saw rotatably mounted to a housing and comprising top and bottom surfaces and a peripheral edge, said bottom surface comprising a turbine blower, said housing comprising an opening adjacent said saw top surface, and leading to a container positioned underneath said saw bottom surface and comprising an outlet;
a chipping element positioned near said opening; and
a conveyor for conveying a cut tree,
wherein when engaging a tree with said saw during rotation thereof, the tree is cut and subsequently conveyed by said conveyor to said chipping element to be chipped thereby producing chips, the rotational movement of said saw conveying the chips into said container via said opening, said turbine blower means providing for blowing the chips through said outlet during rotation of said saw.

24.-25. (canceled)

26. A sawing and chipping device according to claim 23, wherein said chipping element comprises a chipping blade mounted along said saw top surface so as to chip the cut tree in the same plane as the cutting action of said saw.

27.-28. (canceled)

29. A sawing and chipping device according to claim 23, wherein said housing comprises an open top space for exposing said saw top surface and said chipping element.

30. A sawing and chipping device according to claim 29, wherein said housing further comprises a guiding wall adjacent said open top space.

31. A sawing and chipping device according to claim 23, wherein said turbine blower means comprises turbulating fins.

32.-37. (canceled)

38. A sawing and chipping device for harvesting and chipping trees, said device comprising:
a housing comprising a bottom body portion and an upper body portion upstanding therefrom;
a rotatable saw rotatably mounted to said bottom body portion for cutting a tree during rotation thereof;
a conveyor for conveying the cut tree, said conveyor being mounted to said upper body portion and extending therefrom above the saw, said conveyor comprising a pair of spaced apart arm structures extending from said upper body portion above said saw for engaging and conveying therebetween the cut tree, each said arm structure comprising a spur-worm gear assembly, each said spur-worm gear assembly comprising a rotating axle having a rear end mounted to said upper body portion and a front free end, a worm gear being mounted on said axle near said front free end, a spur gear being mounted on said axle near said rear end, during rotation of said axles of each of said spur-worm gear assembly, said worm gears thereof convey the cut tree towards said spur gears which push the cut tree downwardly,
wherein when engaging a tree with said saw during rotation thereof, the tree is cut and subsequently conveyed by said conveyor towards said upper body portion.

39.-43. (canceled)

44. A sawing and chipping device according to claim 38, wherein said spur gears push the cut tree unto a top surface of said saw, said saw top surface comprising a chipping element for chipping the cut tree conveyed unto said saw top surface.

45. A sawing and chipping device according to claim 38, wherein said bottom body portion further comprises a chipping element, said spur gears push the cut tree unto the chipping element for chipping the cut tree.

46. A sawing and chipping device according to claim 38, wherein said spaced apart arm structures are movable mounted to said upper body portion so as to be selectively moved towards or away from each other during conveying of the cut tree.

47.-48. (canceled)
